(19) United States
(12) Patent Application Publication
(10) Pub. No.: US 2019/0310797 A1
(43) Pub. Date: Oct. 10, 2019

(54) CONTROLLER AND MEMORY SYSTEM INCLUDING THE SAME

(71) Applicant: SK hynix Inc., Gyeonggi-do (KR)

(72) Inventors: Joo Young LEE, Seoul (KR); Hoe Seung JUNG, Seoul (KR)

(21) Appl. No.: 16/168,427

(22) Filed: Oct. 23, 2018

(30) Foreign Application Priority Data
Apr. 10, 2018 (KR) 10-2018-0041734

(51) Int. Cl. G06F 3/06; G06F 11/10

(52) U.S. Cl. CPC G06F 3/0659; G06F 11/1012; G06F 3/0661; G06F 3/0656; G06F 3/0604

(57) ABSTRACT

Provided herein may be a controller and a memory system including the controller. The controller may include a host interface layer, a central process unit, and a buffer memory. The host interface may include a data structure defined by a protocol, and may receive an external request from a host. The central process unit may build the data structure according to the external request or build the data structure in response to an internal request generated during an internal operation. The buffer memory may store the data structure.

### CROSS-REFERENCE TO RELATED APPLICATION

The present application claims priority under 35 U.S.C. § 119(a) to Korean patent application number 10-2018-0041734, filed on Apr. 10, 2018, which is incorporated herein by reference in its entirety.

### BACKGROUND

### 1. Field of Invention

Various embodiments of the present disclosure generally relate to a controller and a memory system including the same, and more particularly, to a controller configured to build a data structure in various modes and a memory system including the same.

### 2. Description of Related Art

A memory system may include a storage device in which data is stored and a controller configured to control the storage device in response to a request from a host.

The storage device may include a plurality of memory devices, each of which may independently operate under control of the controller. Each of the memory devices may be a volatile memory device or a nonvolatile memory device.

As uses of mobile electronic devices have increased, so have uses of nonvolatile memory devices. Under control of a controller, such a memory device may perform a program operation for storing data in a memory cell, a read operation for reading the data stored in the memory cell, and an erase operation for erasing the data stored in the memory cell.

### SUMMARY

Various embodiments of the present disclosure are directed to a controller capable of building a data structure in various modes and perform an operation according to the built data structure, and a memory system including the same.

An embodiment of the present disclosure may provide for a controller including: a host interface layer comprising a data structure defined by a protocol, the host interface layer being configured to receive an external request from a host; a central processing unit configured to build the data structure according to the external request or according to an internal request for an internal operation; and a buffer memory configured to store the data structure.

Another embodiment of the present disclosure may provide for a memory system including: a storage device configured to store data; and a controller configured to control the storage device, wherein the controller decides a handle for a selected mode, among a plurality of modes, builds a data structure for the selected mode corresponding to the decided handle, and returns the handle to a normal mode, among the plurality of modes, when an operation for the selected mode ends.

Another embodiment of the present disclosure may provide for a memory system including: a storage device; and a controller configured to receive an external request from a host and control the storage device based on the external request to perform a normal operation, or based on an internal request to perform an internal operation, wherein the controller is configured to build a data structure defined by an interface protocol with the host, and manage data of the normal operation and data of the internal operation based on the data structure.

### BRIEF DESCRIPTION OF THE DRAWINGS

FIG. 1 is a diagram illustrating a memory system according to an embodiment of the present disclosure.

FIG. 2 is a diagram illustrating a storage device according to an embodiment of the present disclosure.

FIG. 3 is a diagram illustrating a controller according to an embodiment of the present disclosure.

FIG. 4 is a diagram illustrating a central processing unit according to an embodiment of the present disclosure.

FIG. 5 is a diagram illustrating a mode selector according to an embodiment of the present disclosure.

FIG. 6 is a diagram illustrating a buffer manager according to an embodiment of the present disclosure.

FIG. 7 is a diagram illustrating a data structure according to an embodiment of the present disclosure.

FIG. 8 is a diagram illustrating a line list according to an embodiment of the present disclosure.

FIG. 9 is a flowchart illustrating an operation method of a controller according to an embodiment of the present disclosure.

FIG. 10 is a diagram illustrating a memory system including a controller according to an embodiment of the present disclosure.

FIG. 11 is a diagram illustrating a memory system including a controller according to an embodiment of the present disclosure.

FIG. 12 is a diagram illustrating a memory system including a controller according to an embodiment of the present disclosure.

FIG. 13 is a diagram illustrating a memory system including a controller according to an embodiment of the present disclosure.

### DETAILED DESCRIPTION

Various embodiments will now be described more fully with reference to the accompanying drawings; however, elements and features of the present invention may be configured or arranged differently than disclosed herein. Thus, the present invention is not limited to the embodiments set forth herein. Rather, these embodiments are provided so that this disclosure is thorough and complete and fully conveys the scope of the embodiments to those skilled in the art. Also, throughout the specification, reference to “an embodiment,” “another embodiment,” or the like is not necessarily to only one embodiment, and different references to any such phrase are not necessarily to the same embodiment(s).

In the drawing figures, dimensions may be exaggerated for clarity of illustration. It will be understood that when an element is referred to as being “between” two elements, it can be the only element between the two elements, or one or more intervening elements may also be present.

Embodiments are described herein with reference to schematic and sectional illustrations of systems, devices, and intermediate structures. As such, variations from the illustrated shapes of any such element as a result, for example, of manufacturing techniques and/or tolerances, are to be expected. Thus, embodiments should not be construed as limited to the particular shapes of elements or their regions illustrated herein but may include deviations in shapes that result, for example, from manufacturing. In the drawings, lengths and sizes of layers and regions may be exaggerated for clarity. Like reference numerals in the drawings denote like elements.

Terms such as “first” and “second” may be used to identify various components, but they should not limit the various components. Those terms are only used for the purpose of differentiating a component from other components that otherwise have the same or similar names. For example, a first component may be referred to as a second component, and a second component may be referred to as a first component and so forth without departing from the spirit and scope of the present disclosure. Furthermore, “and/or” may include any one of or a combination of the components mentioned.

Furthermore, a singular form may include a plural from and vice versa, unless the context indicates otherwise. Furthermore, “include/comprise” or “including/comprising” used in the specification represents the presence or addition of one or more components, steps, operations, and/or elements but does not preclude the presence or addition of other component(s), step(s), operation(s), and/or element(s).

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

It is also noted that in this specification, “connected/coupled” refers to one component not only directly coupling another component but also indirectly coupling another component through one or more intermediate components. On the other hand, “directly connected/directly coupled” refers to one component directly coupling another component without an intermediate component.

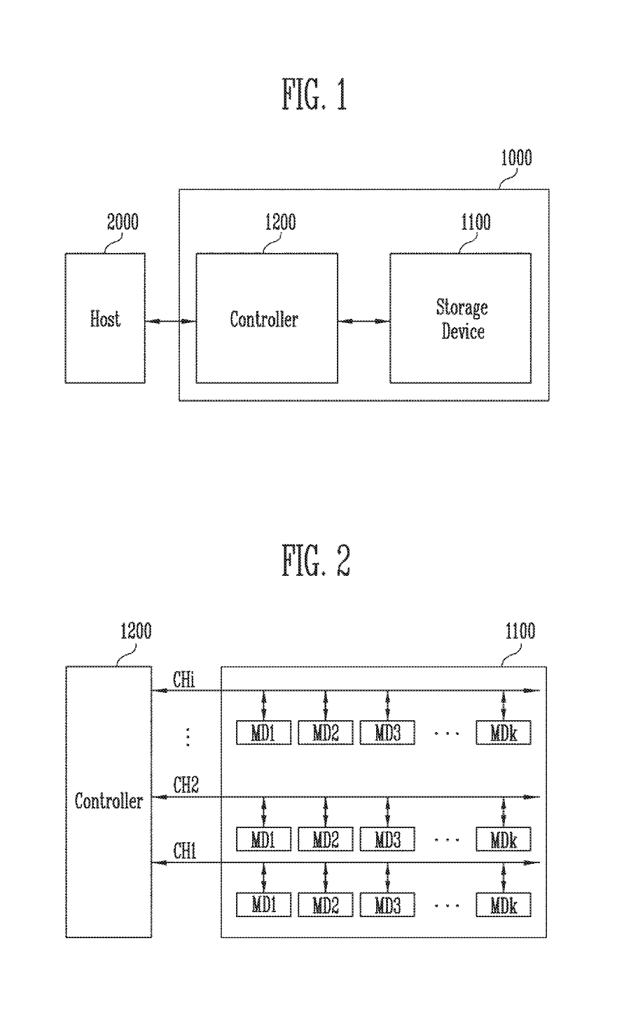

FIG. 1 is a diagram illustrating a memory system 1000 according to an embodiment of the present disclosure.

Referring to FIG. 1, the memory system 1000 may include a storage device 1100 in which data is stored and a controller 1200 configured to control the storage device 1100.

The storage device 1100 may include a plurality of memory devices. Each of the memory devices may include a plurality of memory cells in which data is stored. Under control of the controller 1200, the storage device 1100 may program data, output the stored data to the controller 1200, or erase the stored data.

The controller 1200 may control the storage device 1100 in response to a request from a host 2000, and if necessary, control the storage device 1100 through an internal operation even when there is no request from the host 2000. For example, the internal operation may be a sudden power off recovery operation or an error correction operation, and also include various other operations. The sudden power off recovery operation may be an operation performed when the memory system 1000 is rebooted in the case where power supply is suddenly interrupted. The error correction operation may be an operation of detecting and correcting an error in data read from the storage device 1100 during a read operation.

The host 2000 may communicate with the storage device 1100 through the controller 1200 by means of an interface protocol such as peripheral component interconnect-express (PCI-e or PCIe), advanced technology attachment (ATA), serial ATA(SATA), parallel ATA (PATA), or serial attached SCSI (SAS). Other examples of the interface protocol between the host 2000 and the storage device 1100 include various interfaces such as a universal serial bus (USB), a multi-media card (MMC), an enhanced small disk interface (ESDI), or integrated drive electronics (IDE).

When a program operation is performed in which data received from the host 2000 is programmed to the storage device 1100, the received data may be managed based on a data structure determined according to an interface protocol. The data structure means a structure in which data characteristics are represented in a logical viewpoint. The data structure built according to the interface protocol may be used during a subsequent program operation. In contrast to the data received from the host 2000 for the program operation, data generated in an internal operation of the memory system 1000 does not pass through the interface protocol, and thus a separate data structure may be built and managed. However, when internally-generated data is managed with the separate data structure, the controller 1200 is required to build the new data structure, which takes time and increases the load on the controller 1200.

Accordingly, in various embodiments of the present disclosure, an operation time and a load of the controller 1200 may be reduced by building an identical data structure in different modes.

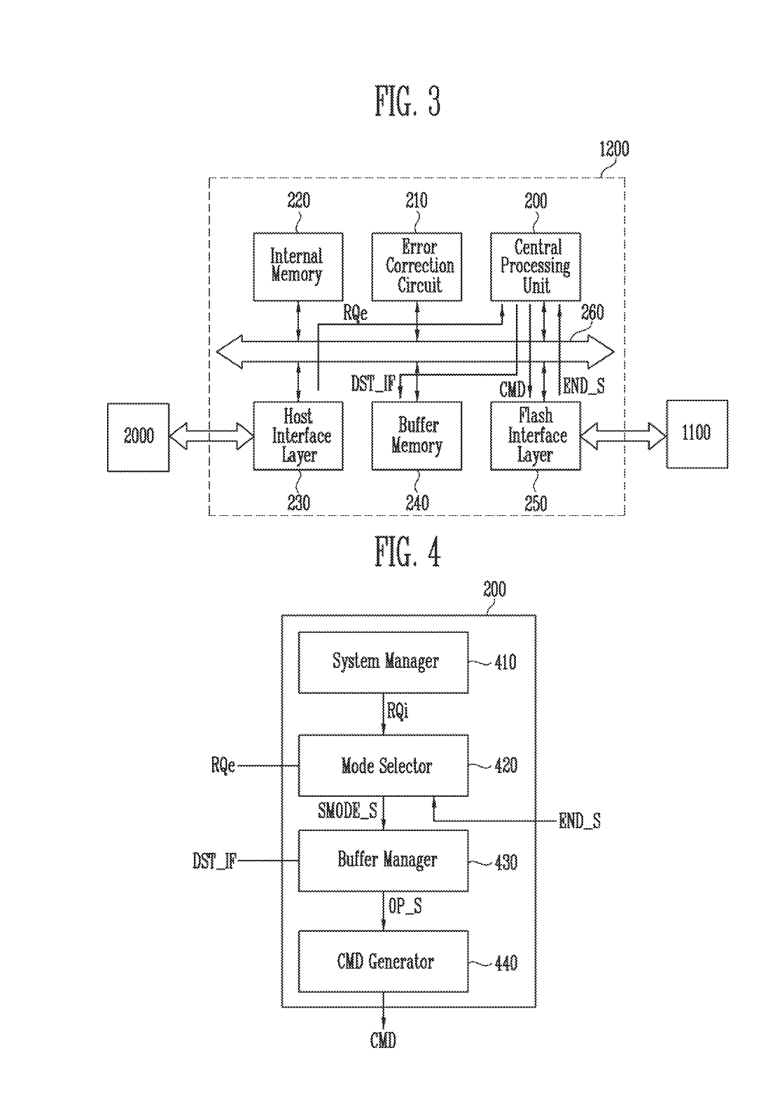

FIG. 2 is a diagram illustrating a storage device according to an embodiment of the present disclosure, for example, the storage device 1100 of FIG. 1.

Referring to FIG. 2, the storage device 1100 may include a plurality of memory devices. For example, i groups of memory devices MD1 to MDk may communicate with the controller 1200 through i channels CH1 to Chi, respectively, where each of i and k is a positive integer of 2 or more. The controller 1200 may output a command to only a selected memory device of the memory devices connected to one channel. For example, the controller 1200 may output, among first to k-th memory devices MD1 to MDk connected to a first channel CH1, a first command to a first memory device MD1, and then output a second command to a second memory device MD2. In other words, the controller 1200 may not simultaneously output commands to the first and second memory devices MD1 and MD2.

FIG. 3 is a diagram illustrating a controller according to an embodiment of the present disclosure, for example, the controller 1200 of FIG. 1.

Referring to FIG. 3, the controller 1200 may include a central processing unit (CPU) 200, an error correction circuit 210, an internal memory 220, a host interface layer 230, a buffer memory 240, and a flash interface layer 250. The CPU 200, the error correction circuit 220, the host interface layer 230, the buffer memory 240, and the flash interface layer 250 may communicate with each other through a bus 260.

The CPU 200 may generate a command and an address in response to an external request RQe received from the host 2000, and perform various calculations required for an operation of the memory system 1000.

The error correction circuit 210 may encode data received from the host 2000 in a program operation, and decode data received from the selected memory device in a read operation. For example, the error correction circuit 210 may correct an error when the error is detected during a decoding operation.

The internal memory 220 may store various kinds of information necessary for an operation of the controller 1200. For example, the internal memory 220 may include address map tables indicating the mapping relationship between logical addresses and physical addresses. The address map tables may also be stored in the memory devices. The address map tables stored in the memory devices may be loaded again to the internal memory 220 when the memory system 1000 is booted. The internal memory 220 may be implemented with at least one or more among a random access memory (RAM), a dynamic RAM (DRAM), a static RAM (SRAM), a cache, and a tightly coupled memory (TCM).

The host interface layer 230 may exchange an external request RQe, an address and data between the controller 1200 and the host 2000. For example, the host interface layer 230 may receive the external request RQe, an address and data from the host 2000, and transmit data read from the storage device 1100 to the host 2000.

The buffer memory 240 may temporarily store, while the memory system 1000 performs an operation, data needed for the operation. For example, the buffer memory 240 may temporarily store original program data in a program operation until the program operation of the selected memory is passed. The buffer memory 240 may temporarily store data read from the memory device in a read operation. The buffer memory 240 may store address mapping information necessary for the operation of the memory system 1000, and may frequently update the address mapping information. In addition, the buffer memory 240 may temporarily receive and store data structure information DST_IF. The buffer memory 240 may be implemented with a DRAM.

The flash interface layer 250 may exchange a command, an address, and data between the controller 1200 and the storage device 1100. For example, the flash interface layer 250 may output the command, address and the data to the storage device 1100 through channels, and receive data from the storage device 1100. In addition, the flash interface layer 250 may perform a queuing operation for changing a sequence of commands CMD generated by the CPU 200 depending on the state of the storage device 1100, and sequentially output the queued commands to the storage device 1100. In addition, the flash interface layer 250 may determine whether the selected operation ends or is being executed in the storage device 1100. The flash interface layer 250 may transmit an end signal END_S to the CPU 200 when the operation in the storage device 1100 ends.

In the controller 1200, the CPU 200 may output the data structure information DST_IF in order to build a data structure for data corresponding to the external request RQe. In addition, the CPU 200 may output the data structure information DST_IF in order to build a data structure for data generated when an internal operation of the controller 1200 is performed. In various embodiments, the CPU 200 may use one fixed data structure without building different data structures for pieces of data of different modes. For example, a data structure built for data corresponding to the external request RQe may also be applied to data generated during a rebooting operation or an error correction operation after sudden power off.

In this way, when one data structure is used, an operation for building a new data structure may be omitted, and thus an activation load of the CPU 200 may be reduced.

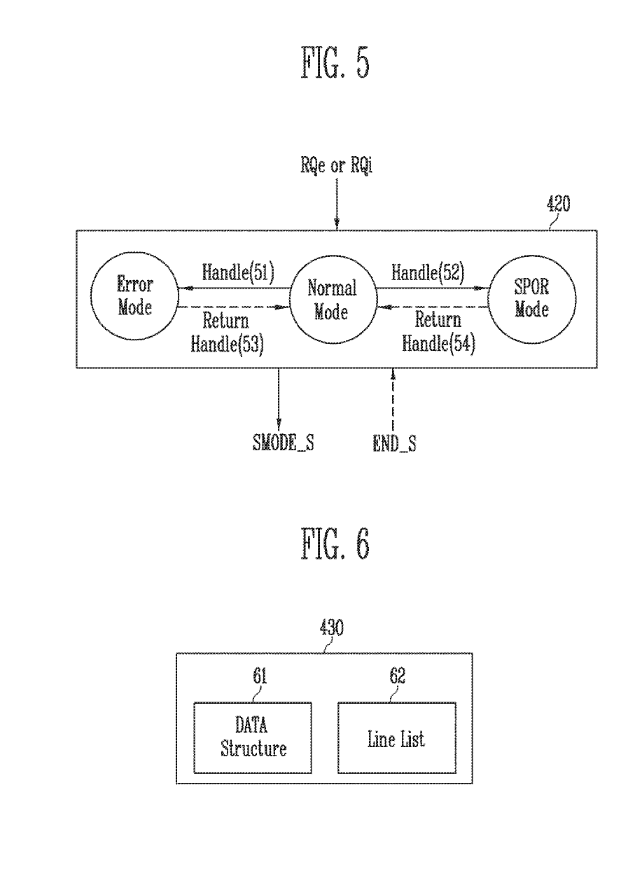

FIG. 4 is a diagram illustrating a central processing unit (CPU) according to an embodiment of the present disclosure, for example, the CPU 200 of FIG. 3.

Referring to FIG. 4, the CPU 200 may include a system manager 410, a mode selector 420, a buffer manager 430, and a command (CMD) generator 440.

The system manager 410 may generate an internal request RQi, when an internal operation of the controller 1200 is needed. For example, the system manager 410 may generate the internal request RQi for the internal operation, instead of a request from the host 2000. Accordingly, the internal request RQi may be different from the external request RQe received from the host 2000. For example, the system manager 410 may generate an internal request RQi for a rebooting operation after the sudden power off, or an internal request RQi for an error correction operation.

The mode selector 420 may output a mode selection signal SMODE_S in response to an external request RQe received from the host 2000, or an internal request RQi received from the system manager 410. For example, the mode selector 420 may control a handle for building a data structure in response to the external request RQe or the internal request RQi. For example, the mode selector 420 may select a normal mode in response to the external request RQe, or select an internal mode in response to the internal request RQi, and may decide the handle for the selected internal mode.

In various embodiments, the handle may be a command for building the data structure. For example, when the external request RQe is received, the mode selector 420 may output a mode selection signal SMODE_S for an operation in the normal mode. The handle may be designated as a default in the normal mode. When the internal request RQi is received, the mode selector 420 may output a mode selection signal SMODE_S for an operation in a mode (i.e., an internal mode such as an error mode or a sudden power off recovery (SPOR) mode), which is different from the normal mode. In order to use an identical data structure in the internal mode, the mode selector 420 may convert the handle to build the data structure in a selected mode. In other words, the mode selector 420 may convert only the handle according to the selected mode, and output the mode selection signal SMODE_S for the selected mode.

The mode selector 420 may return the handle to the normal mode in response to the end signal END_S. When an operation corresponding to the normal mode ends, the handle may be maintained in the normal mode without a change. When an operation corresponding to the internal mode ends, the handle may return to the normal mode.

The buffer manager 430 may analyze data used in a mode for which the handle is decided to build a data structure. The buffer manager 430 may build the data structure based on a data structure defined by a protocol of the host interface layer 230. For example, the buffer manager 430 may build a data structure having the same structure as the data structure defined by the protocol of the host interface layer 230.

In addition, the buffer manager 430 may build a line list about the data structure, and output data structure information DST_IF and an operation signal OP_S for the data structure and the line list. The data structure information DATA_IF may be for storing the data structure and the line list in the buffer memory 240. The operation signal OP_S may be for performing an operation. In other words, only when the data structure for the selected operation is built, may the selected operation be executed. When the data structure information DST_IF for building the data structure is output, the operation signal OP_S may also be output at substantially the same time.

The command generator 440 may generate and output a command CMD corresponding to the selected operation in response to the operation signal OP_S.

FIG. 5 is a diagram illustrating a mode selector according to an embodiment of the present disclosure, for example, the mode selector 420 of FIG. 4.

Referring to FIG. 5, the mode selector 420 may select a mode in response to the external request RQe or the internal request RQi, and convert a handle for building a data structure in the selected mode. For example, the mode may be selected from among a normal mode, an error mode, or a sudden power off recovery (SPOR) mode. There may be other modes from which to select as well. In the present embodiment, as illustrated in FIG. 5, the case where any one of three modes is selected is described by way of example.

In the normal mode, the external request RQe is received through the host interface layer 230 of FIG. 3, and the operation corresponding to the external request RQe is performed. The handle for building a data structure may be designated to the normal mode by default. Since the data structure may be built according to a protocol of the host interface layer 230, in the normal mode, the mode selector 420 may output a mode selection signal SMODE_S corresponding to the normal mode without converting the handle.

In the error mode, the controller 1200 performs an internal operation such as error correction without intervention of the host 2000. For example, when a read operation is performed in the storage device 1100, the error correction circuit 210 may decode the read data to detect an error. When the number of error bits is included in a correctable range, the error may be corrected. The data used in the controller 1200 is not related to the protocol of the host interface layer 230. Thus, the controller 1200 is required to perform a separate operation to build a data structure. However, in the present embodiment, the same data structure used in the normal mode may be used in the error mode by converting the handle designated to the normal mode to the error mode (operation 51). The mode selector 420 may convert the handle into the error mode so that such a data structure may be used, and output a mode selection signal SMODE_S corresponding to the error mode.

In a sudden power off recovery (SPOR) mode, the controller 1200 performs an internal operation such as SPOR without intervention of the host 2000. For example, when the sudden power off (SPO) occurs in which the power supplied to the memory system 1000 is suddenly 1o Interrupted, and the memory system 1000 is rebooted, the controller 1200 may perform the SPOR operation for determining a state of the memory system 1000 before the SPO occurred. In the SPOR operation, various pieces of data for the memory system 1000 may be delivered between the controller 1200 and the storage device 1100. Data generated during the SPOR operation is not related to the protocol of the host interface layer 230, so that the controller 1200 is required to perform a separate operation to build a data structure. However, in the present embodiment, the data structure used in the normal mode may be used in the SPOR mode by converting only the handle designated to the normal mode to the SPOR MODE (operation 52).

When a corresponding operation ends in the error mode or the SPOR mode, the mode selector 420 may receive an end signal END_S. The mode selector 420 may then return the handle from the error or SPOR mode to the normal mode in response to the end signal END_S (operations 53 and 54).

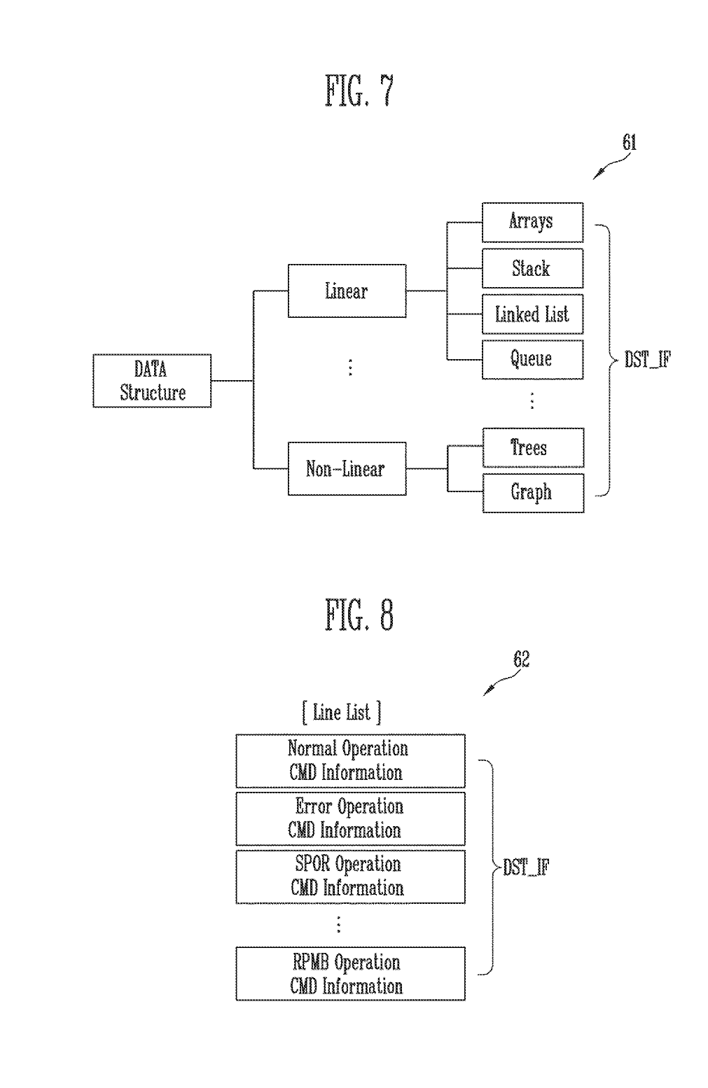

FIG. 6 is a diagram illustrating a buffer manager according to an embodiment of the present disclosure, for example, the buffer manager 430 of FIG. 4.

Referring to FIG. 6, the buffer manager 430 may build a data structure 61 and a line list 62 in response to the mode selection signal SMODE_S. The data structure 61 may be used to efficiently store and manage data. The data structure 61 may be built by summarizing core content of data according to characteristics and types of the data. Accordingly, the data structure 61 may be used to efficiently manage data to be used. An embodiment of the data structure will be described with reference to FIG. 7. FIG. 7 is a diagram illustrating the data structure 61 of FIG. 6.

Referring to FIG. 7, the data structure 61 may be built in various ways depending on design schemes. The data structure 61 may be built in a pattern defined by the protocol of the host interface layer 230.

As described above, in the present embodiment, the data structure is built in the pattern defined by the protocol in the normal mode, but in modes other than the normal mode, the protocol does not built a data structure. Accordingly, the buffer manager 430 may built the data structure 61 for the mode in which the handle has been received. That is, in other modes, the buffer manager 430 may build the same data structure as the data structure built in the normal mode.

As illustrated in FIG. 7, the data structure 61 may include information for indicating whether data is linear or nonlinear. Sequentially enumerated data may be classified as linear data, and other data that is not sequentially enumerated may be classified as nonlinear data. The linear data may be classified into arrays, a stack, a linked list, or a queue. The nonlinear data may be classified into trees or a graph. By way of example, the linear data and the nonlinear data may be classified according to various conditions.

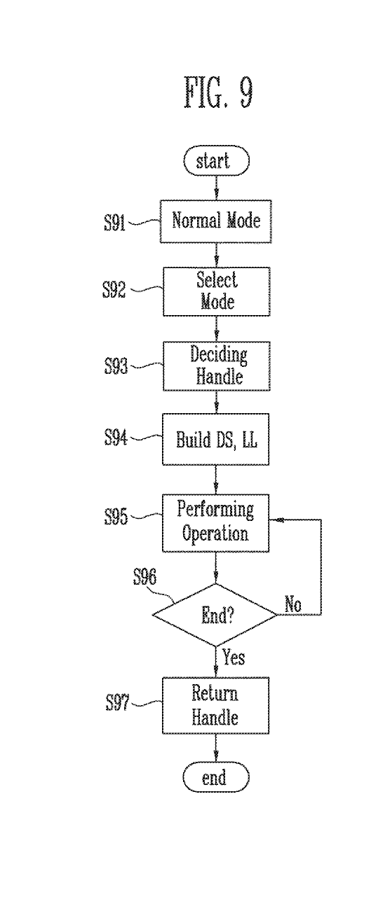

When the data structure is built as shown in FIG. 7, the buffer manager 430 may build the line list 62 for corresponding data. An embodiment of the line list will be described with reference to FIG. 8. FIG. 8 is a diagram illustrating the line list 62 of FIG. 6.

Referring to FIG. 8, the line list 62 may include information about a mode in which the data structure 61 is built. For example, the line list 62 may include normal operation command (CMD) information, error operation CMD information, sudden power off recovery (SPOR) operation CMD information, and replay protected memory block (RPMB) operation CMD information. The RPMB operation means allocating and configuring a particular region inside the memory for authentication.

The buffer manager 430 of FIG. 4 may generate and output the information shown in FIGS. 7 and 8 as data structure information DST_IF. The data structure information DST_IF from the buffer manager 430 may be stored in the buffer memory 240 of FIG. 3. For example, the buffer manager 430 builds the data structure 61 and the line list 62 to output the data structure information DST_IF. The buffer memory 240 may store the data structure 61 and the line list 62 for each operation according to information included in the data structure information DST_IF.

FIG. 9 is a flowchart illustrating an operation method of a controller, for example, the controller 1200 of FIGS. 1 and 3, according to an embodiment of the present disclosure.

Referring to FIGS. 1 to 9, the controller 1200 may be set to the normal mode before performing a specific operation (operation S91). In other words, the default mode of the controller 1200 may be the normal mode. [0074] When a specific operation starts, a request for executing the specific operation is generated, and a mode may be selected depending on whether the request is the external request RQe by the host 2000 or the internal request RQi by the controller 1200 (operation S92). When the external request RQe is received from the host 200, the normal mode may be continuously maintained. When the internal operation of the memory system 1000 is performed, the system manager 410 may generate the internal request RQi, and a mode may be selected according to the internal request RQi. When the internal request RQi is received, the mode selector 420 may select a mode corresponding to the internal request RQi. When the mode is selected, the mode selector 420 may decide a handle for building a data structure for the selected mode (operation S93). When the handle is decided for the selected mode, the buffer manager 430 may build the data structure DS and the line list LL.

The data structure DS may be determined by the protocol of the host interface layer 230. Data may be managed based on a common data structure (i.e., the data structure DS), even when modes are different. The line list LL may include information about a mode in which the data structure DS is built. In other words, the data structure DS and the line list LL may be used to efficiently manage the data of each operation.

The buffer manager 430 may output the data structure information DST_IF including the data structure DS and the line list LL. The buffer memory 240 may receive the data structure information DST_IF to store the data structure DS and the line list LL for each operation or each mode. Alternatively, the data structure DS and the line list LL may be stored in a storage region inside the controller 1200.

When outputting the data structure information DST_IF, the buffer manager 430 may output a command CMD, and the storage device 1100 may perform a selected operation in response to the command CMD (operation S95).

The flash interface layer 250 may determine whether the selected operation ends or is being executed in the storage device 1100 (operation S96). When it is determined that the selected operation ends (YES at S96), the flash interface layer 250 may generate and transmit an end signal END_S to the mode selector 420. When the end signal END_S is received, the mode selector 420 may return the handle to the normal mode. In operation S96, ‘No’ means that the selected operation continuously proceeds in the storage device 1100.

As described above, in a mode in which the data structure DS is not built by the protocol, the controller 1200 may decide a handle for the selected mode, and build the data structure DS for the selected mode corresponding to the decided handle. Accordingly, additional time is not needed to newly build the data structure DS, and data may be consistently managed using one data structure. In addition, since use of firmware for building a new data structure may be prevented, a code for driving new firmware is not required.

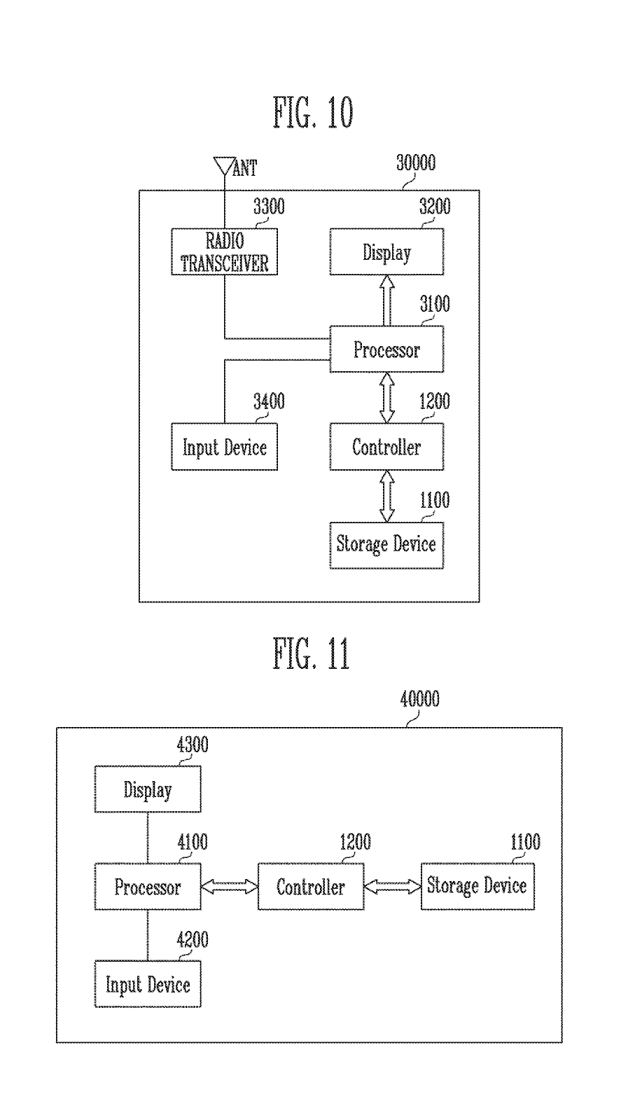

FIG. 10 is a diagram illustrating an embodiment of a memory system 30000 including a controller according to an embodiment of the present disclosure, for example, the controller 1200 shown in FIG. 1.

Referring to FIG. 10, the memory system 30000 may be embodied in a cellular phone, a smartphone, a tablet personal computer (PC), a personal digital assistant (PDA) or a wireless communication device. The memory system 30000 may include a storage device 1100 and the controller 1200 capable of controlling the operation of the storage device 1100. The controller 1200 may control a data access operation, e.g., a program operation, an erase operation, or a read operation, of the storage device 1100 under control of a processor 3100.

Data programmed in the storage device 1100 may be outputted through a display 3200 under control of the controller 1200.

A radio transceiver 3300 may transmit and receive radio signals through an antenna ANT. For example, the radio transceiver 3300 may convert a radio signal received through the antenna ANT into a signal capable of being processed in the processor 3100. Therefore, the processor 3100 may process a signal output from the radio transceiver 3300 and transmit the processed signal to the controller 1200 or the display 3200. The controller 1200 may transmit a signal processed by the processor 3100 to the storage device 1100. Furthermore, the radio transceiver 3300 may convert a signal output from the processor 3100 into a radio signal, and output the converted radio signal to an external device through the antenna ANT. An input device 3400 may be used to input a control signal for controlling the operation of the processor 3100 or data to be processed by the processor 3100. The input device 3400 may be embodied in a pointing device such as a touch pad and a computer mouse, a keypad or a keyboard. The processor 3100 may control the operation of the display 3200 such that data output from the controller 1200, data output from the radio transceiver 3300, or data output form the input device 3400 is output through the display 3200.

In an embodiment, the controller 1200 capable of controlling the operation of the storage device 1100 may be embodied as a part of the processor 3100 or a chip provided separately from the processor 3100.

FIG. 11 is a diagram illustrating an embodiment of a memory system 40000 including a controller according to an embodiment of the present disclosure, for example, the controller 1200 shown in FIG. 1.

Referring to FIG. 11, the memory system 40000 may be embodied in a personal computer (PC), a tablet PC, a net-book, an e-reader, a personal digital assistant (PDA), a portable multimedia player (PMP), an MP3 player, or an MP4 player.

The memory system 40000 may include a storage device 1100 and the controller 1200 capable of controlling a data processing operation of the storage device 1100.

A processor 4100 may output data stored in the storage device 1100 through a display 4300, according to data inputted by an input device 4200. For example, the input device 4200 may be embodied in a pointing device such as a touch pad or a computer mouse, a keypad, or a keyboard.

The processor 4100 may control the overall operation of the memory system 40000 and control the operation of the controller 1200. In an embodiment, the controller 1200 capable of controlling the operation of the storage device 1100 may be embodied as a part of the processor 4100 or a chip provided separately from the processor 4100.

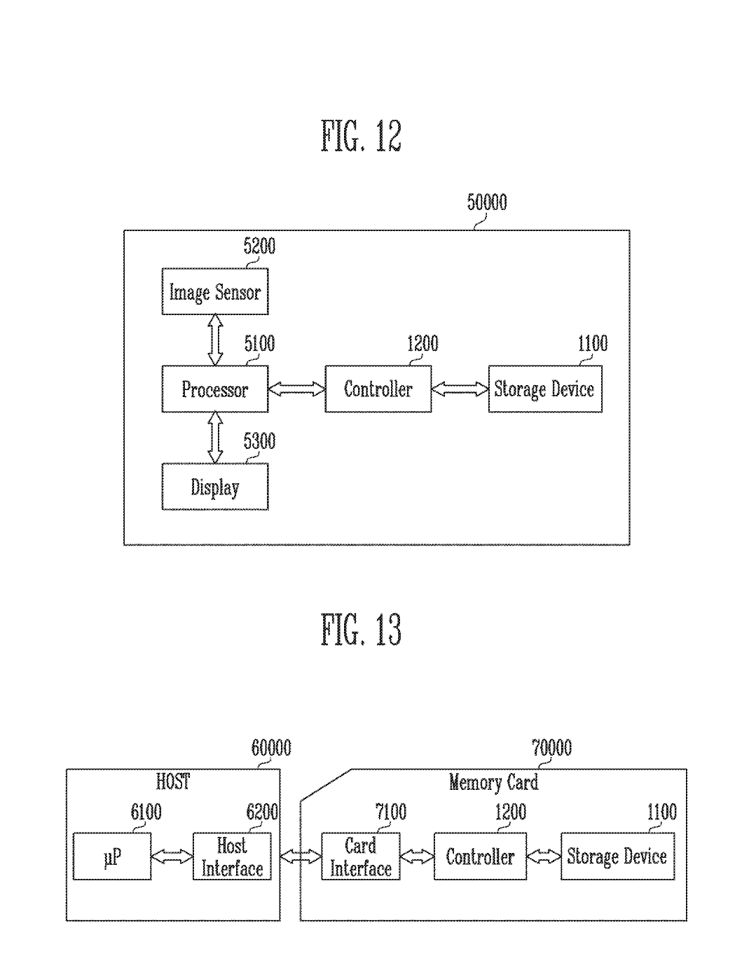

FIG. 12 is a diagram illustrating an embodiment of a memory system 50000 including a controller according to an embodiment of the present disclosure, for example, the controller 1200 shown in FIG. 1.

Referring to FIG. 12, the memory system 50000 may be embodied in an image processing device, e.g., a digital camera, a portable phone provided with a digital camera, a smartphone provided with a digital camera, or a tablet personal computer (PC) provided with a digital camera.

The memory system 50000 may include a storage device 1100 and the controller 1200 capable of controlling a data processing operation, e.g., a program operation, an erase operation, or a read operation, of the storage device 1100.

An image sensor 5200 may convert an optical image into digital signals. The converted digital signals may be transmitted to a processor 5100 or the controller 1200. Under control of the processor 5100, the converted digital signals may be outputted through a display 5300 or stored in the storage device 1100 through the controller 1200. Data stored in the storage device 1100 may be outputted through the display 5300 under control of the processor 5100 or the controller 1200.

In an embodiment, the controller 1200 capable of controlling the operation of the storage device 1100 may be embodied as a part of the processor 5100 or a chip provided separately from the processor 5100.

FIG. 13 is a diagram illustrating an embodiment of a memory system 70000 including a controller according to an embodiment of the present disclosure, for example, the controller 1200 shown in FIG. 1.

Referring to FIG. 13, the memory system 70000 may be embodied in a memory card or a smart card. The memory system 70000 may include a storage device 1100, the controller 1200, and a card interface 7100.

The controller 1200 may control data exchange between the storage device 1100 and the card interface 7100. In an embodiment, the card interface 7100 may include, but is not limited to, a secure digital (SD) card interface or a multi-media card (MMC) interface.

The card interface 7100 may interface data exchange between a host 60000 and the controller 1200 according to a protocol of the host 60000. In an embodiment, the card interface 7100 may support a universal serial bus (USB) protocol, and an interchip (IC)-USB protocol. The card interface 7100 may refer to hardware capable of supporting a protocol which is used by the host 60000, software installed in the hardware, or a signal transmission method.

When the memory system 70000 is connected to a host interface 6200 of the host 60000 such as a personal computer (PC), a tablet PC, a digital camera, a digital audio player, a cellular phone, console video game hardware or a digital set-top box, the host interface 6200 may perform data communication with the storage device 1100 through the card interface 7100 and the controller 1200 under control of a microprocessor 6100.

According to embodiments of the present disclosure, a data structure may be built in various modes by using only one handle through which a data structure is built, and data may be effectively and easily managed by using a data structure in which operations in different modes have an identical structure.

Various embodiments have been disclosed herein, and although specific terms are employed, they are used and are to be interpreted in a generic and descriptive sense and not for purpose of limitation. In some instances, as would be apparent to one skilled in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A controller comprising:
a host interface layer comprising a data structure defined by a protocol, the host interface layer being configured to receive an external request from a host;
a central processing unit configured to build the data structure according to the external request or according to an internal request for an internal operation; and
a buffer memory configured to store the data structure.

2. The controller according to claim 1, wherein the central processing unit comprises:
a system manager configured to generate the internal request for the internal operation;
a mode selector configured to select a mode, among a plurality of modes, for building the data structure according to the external request or the internal request, and output a mode selection signal for the selected mode; and
a buffer manager configured to build the data structure corresponding to the selected mode in response to the mode selection signal, and output data structure information for the data structure.

3. The controller according to claim 1, wherein the internal operation is autonomously performed inside the controller without control of the host.

4. The controller according to claim 1, wherein the internal operation comprises a sudden power off recovery operation to be performed when rebooting after power supply is suddenly interrupted, or an operation of detecting and correcting an error in data read from a storage device during a read operation.

5. The controller according to claim 2, wherein the mode selector selects a normal mode or an internal mode, among the plurality of modes, in response to the external request or the internal request, and decides a handle for the selected mode so that the data structure is built for the selected mode.

6. The controller according to claim 5, wherein the handle is a command for building the data structure.

7. The controller according to claim 5, wherein the mode selector returns the handle to the normal mode when the operation corresponding to the internal request ends.

8. The controller according to claim 2, wherein, based on the data structure defined in the host interface layer, the buffer manager analyzes data to be used in the selected mode and builds the data structure.

9. The controller according to claim 8, wherein the buffer manager builds a line list including information about a mode in which the data structure is built.

10. The controller according to claim 9, wherein the buffer manager outputs data structure information about the data structure and the line list.

11. The controller according to claim 10, wherein, when outputting the data structure information, the buffer manager outputs an operation signal for the selected mode.

12. The controller according to claim 11, wherein the central processing unit further comprises a command generator configured to generate a command for controlling a storage device in response to the operation signal.

13. The controller according to claim 10, further comprising a buffer memory configured to store the data structure and the line list built according to the data structure information.

14. The controller according to claim 1, wherein the data structure comprises information on which data is classified into linear data or nonlinear data.

15. The controller according to claim 14, wherein the linear data includes arrays, a stack, a linked list, or a queue.

16. The controller according to claim 14, wherein the nonlinear data includes trees or a graph.

17. A memory system comprising:
a storage device configured to store data; and
a controller configured to control the storage device,
wherein the controller decides a handle for a selected mode, among a plurality of modes, builds a data structure for the selected mode corresponding to the decided handle, and returns the handle to a normal mode, among the plurality of modes, when an operation for the selected mode ends.

18. The memory system according to claim 17, wherein the controller uses the data structure to manage data for each of the modes.

19. The memory system according to claim 17, wherein, in the normal mode the controller operates in response to an external request output from a host.

20. The memory system according to claim 19, wherein, in an internal mode to be performed inside the controller other than the normal mode, data is managed using the data structure that is used in the normal mode.
